(19) United States
(12) Patent Application Publication
(10) Pub. No.: US 2016/0003274 A1
(43) Pub. Date: Jan. 7, 2016

(54) Connector

(71) Applicant: MAGLOC IP LIMITED, Glossop Derbyshire (GB)

(72) Inventor: Anthony Bernard Garlick, Old Glossop (GB)

(21) Appl. No.: 14/770,146

(22) PCT Filed: Feb. 25, 2014
(86) PCT No.: PCT/GB2014/050555

§ 371 Date: Aug. 25, 2015

(30) Foreign Application Priority Data
Feb. 25, 2013 (GB) 1303240.4

(51) Int. Cl. F16B 7/04; F16B 2/10

(52) U.S. Cl. CPC F16B 7/0413; F16B 2/10

(57) ABSTRACT

The present invention pertains generally two mechanical connectors for connection of two components designed to enable single handed operation. The connector comprises a female body having a longitudinal axis comprising a first body portion and a second body portion arranged to communicate to define a receiving chamber for receipt of a male engaging member. At least one retaining clip is provided for retaining a male engaging member in the receiving chamber, the at least one retaining clip being moveable between an opening configuration for receipt of a male engaging member and a closed configuration for restraining movement of a male engaging member in the longitudinal axis. The first and second body portion are arranged to retain the at least one clip there between. This enables fast assembly of a light weight, effective connector.

The present invention pertains generally to mechanical connectors. More specifically, the invention relates to a mechanical connector for the connection of two components, designed to enable single hand operation.

Existing connectors rely on the interaction between at least two components. The alignment and engagement of these components usually requires a degree of dexterity and, unless one component is fixed, necessitates a two-handed operation to both align and engage the components correctly. This alignment often requires a level of dexterity and accuracy of orientation that may not be present due, for example, to the fatigue or the restricted movement of the operator. A further drawback of many current connection systems is the complexity of disconnection and a further drawback is the complexity of manufacture. This is manifested if the connector is to be suitable for withstanding forces such as from a dog on a lead where the forces required to be withstood mean the connector must have significant strength. The present invention overcomes such problems.

According to the present invention there is a connector comprising:
a female body having a longitudinal axis comprising a first body portion and a second body portion arranged to communicate to define a receiving chamber for receipt of a male engaging member;
at least one retaining clip for retaining a male engaging member in the receiving chamber, the at least one retaining clip being moveable between an open configuration for receipt of a male engaging member and a closed configuration for restraining movement of a male engaging member in the longitudinal axis;
wherein the first and second body portions are arranged to retain the at least one retaining clip therebetween.

There are significant benefits associated with the present invention. One benefit is the capability of assembling such a connector due to the first and second body portions being arranged to retain the at least one clip therebetween. Accordingly, the clip can be positioned in communication with the first or second body portion and the other of the first or second body portion can be assembled thus retaining the clip therebetween and providing ease of assembly.

The female body is beneficially arranged to receive an element capable of being attracted by a magnet or even more beneficially including a magnet. The female body portion is arranged and configured to retain the element or magnet therein. It is beneficial that a magnet is provided in the female body. A receiving zone for the magnet is beneficially provided preferably formed by the first and second body portion. This allows ease of manufacture. A benefit of utilising a magnet is during connection to a male engaging member the magnet beneficially aligns the male engaging member. Furthermore, the magnet attracts the male engaging member which effectively draws the male engaging member into the receiving chamber and on the way causes radial movement of the at least one retaining clip outwardly as the male engaging member is drawn into the receiving chamber.

Beneficially magnetic attraction draws the male and female engaging members together. The force of the attraction is preferably sufficient to move the at least one retaining clip between the closed and opened configuration. Operation of the connector benefits a user significantly due to the automatic alignment of the male engaging element and the female body.

The at least one clip is beneficially arranged to move from the closed configuration to the opening configuration upon transfer of a male engaging member into the chamber. The at least one retaining clip is preferably at least partially moveable between a radially outwardly open configuration and a radially inwardly closed configuration.

The first and second body portions are preferably radially separable. This separation enables ease of assembly.

The first and second body portions preferably define an annular opening into the receiving chamber. It will be appreciated that this enables a male engaging element to locate into the female body at any rotational orientation, which is particularly beneficial in use.

The at least one retaining clip is beneficially rotationally moveable relative to the first and second body portion. The at least one clip is preferably pivotally retained between the first and second body portion. At least a portion of the at least one clip is preferably seated between the first and second body portion. The at least one retaining clip is preferably rotationally secured about an axis substantially perpendicular to the longitudinal axis of the female body. As such, the at least one retaining clip is preferably arranged such that a force can be applied generally perpendicular to the longitudinal length of the female body thus causing pivoting action to cause the clip to rotate from the closed to the open configuration.

The at least one retaining clip preferably comprises a longitudinal length extending between a first and second end and is pivotally retained at a location intermediate the first end and the second end. The at least one clip preferably comprises a first body engagement element for resisting movement in the longitudinal axis of the first body portion and a second body engagement element for resisting movement in the longitudinal axis of the second body portion. Preferably the first body engagement element and preferably the second body engagement element comprise a spigot for seating into a receiving portion in the first body portion and preferably second body portion respectively.

It will be appreciated that there are beneficially provided at least two and even more beneficially there are provided two clips. The clips are beneficially provided radially opposite each other on opposing sides of the female body portion. This aids in operation as a user can pinch the first and second clips between their finger and thumb for example to enable release of a male engaging member. Furthermore, positioning of the clips in this manner prevents unintentional release of a male engaging member from the female body.

The at least one retaining clip preferably comprises a retaining element arranged to retain a male engaging member in the receiving chamber in the closed configuration. The retaining element is beneficially moveable between the closed configuration and the open configuration. The retaining element beneficially comprises a retaining surface arranged to seat against a male engaging member and prevent withdrawal of a male engaging member from the receiving chamber. The retaining element beneficially moves generally radially outwardly (actually arcs but the movement is generally radially outwardly) and beneficially in a direction substantially perpendicular to the longitudinal axis of the female body.

The retaining surface beneficially substantially aligns in the same longitudinal axis with the axis about which the clip rotates. It is important that force applied to the male engaging member is then transferred through a substantially straight line in the longitudinal axis between the retaining element and the axis about which the clip rotates. This reduces any possibility of unintentional or accidental release of the male engaging member from the female body. In the event of offset of the axis about which the clip rotates and the surface of the retaining member through which force is applied there is a possibility of accidental release particularly if the male engaging member is rotating relative to the female body.

At least one clip is preferably arranged such that force applied to the retaining surface is in a longitudinal axis and this longitudinal axis beneficially intersects the axis about which the clip rotates.

A biasing means, preferably a spring, is provided to bias the at least one clip to the closed configuration, and preferably extends between a first and second clip. Accordingly, the biasing means beneficially ensures that a first and second clip are biased to the closed configuration. The biasing means preferably extends generally perpendicular to the longitudinal axis of the female body.

The connector beneficially further comprises at least one collar portion arranged to at least partially encase the first and second body portions. The at least one collar is preferably drawn over the first and second body portion in the longitudinal axis. The collar preferably comprises at least one, and preferably two, recesses or grooves in the longitudinal axis arranged to accommodate the at least one clip, and beneficially two clips, where each groove accommodates a clip. A second collar is beneficially provided again arranged to at least partially encase the first and second body portions and arranged to be drawn over the first and second body portions in the longitudinal axis but in the opposing direction to the first collar. The first and beneficially second collar are provided which effectively ensure that the first and second body portions cannot accidentally release from one another. The first and second body portions are preferably arranged to interlock, and preferably clip together, however, the first and preferably second collar ensure that accidental lateral disconnection of the first and second body portions is impossible. The first collar beneficially has an opening through which an eyelet or fixing portion of the connector passes. The second collar beneficially defines an opening to the receiving chamber, the opening preferably being defined by an annular rim.

The at least one clip beneficially comprises a contact portion for contacting the male engaging member wherein the contact portion preferably tapers inwardly enabling the at least one clip to be deflected radially outwardly on introduction of a male engaging member through the opening to the receiving chamber.

The connector preferably further includes a male engaging member. The male engaging member beneficially includes a portion capable of being attracted by a magnet or else in one embodiment includes a magnet. It is beneficial that a portion capable of being attracted by a magnet is included in the male engaging member and the female body includes a magnet therein. The magnet is beneficially sufficiently strong such that as the male engaging member is brought into the vicinity of the female body, the magnet in the female body draws the male engaging member into the receiving chamber and accordingly deflects the at least one clip from the closed to the open configuration.

The male engaging member preferably comprises a head and a body portion separated by an axial groove. A clip contact surface is defined by a rearward surface of a head, preferably arranged to seat against the retaining surface of the retaining element. The clip contact surface is beneficially annular. The head beneficially projects from the body. The head beneficially tapers inwardly towards the tip.

Also according to the present invention there is a method of assembling a connector comprising the steps of:
providing a first body portion and a second body portion configured together to form a female body defining a receiving chamber for receipt of a male engaging member, the female body having a longitudinal axis;
providing at least one retaining clip,
positioning the retaining clip between the first body portion and second body portion such that the first body portion and second body portion retain the retaining clip therebetween, the at least one retaining clip being arranged to retain a male engaging member in the receiving chamber, the at least one retaining clip being moveable between an open configuration for receipt of a male engaging member and a closed configuration for restraining movement of a male engaging member in the longitudinal axis.

The present invention will now be described by way of example only with reference to the accompanying drawings in which:

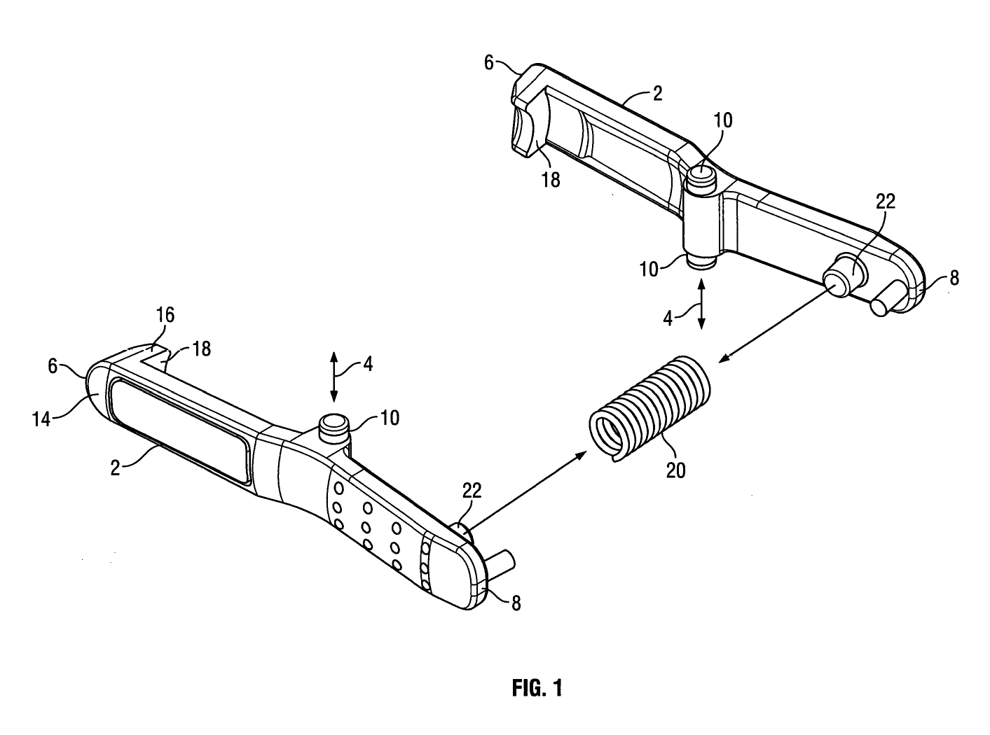

FIGS. 1 to 6 show schematic perspective views of the components and assembly process of a connector according to an exemplary embodiment of the present invention.

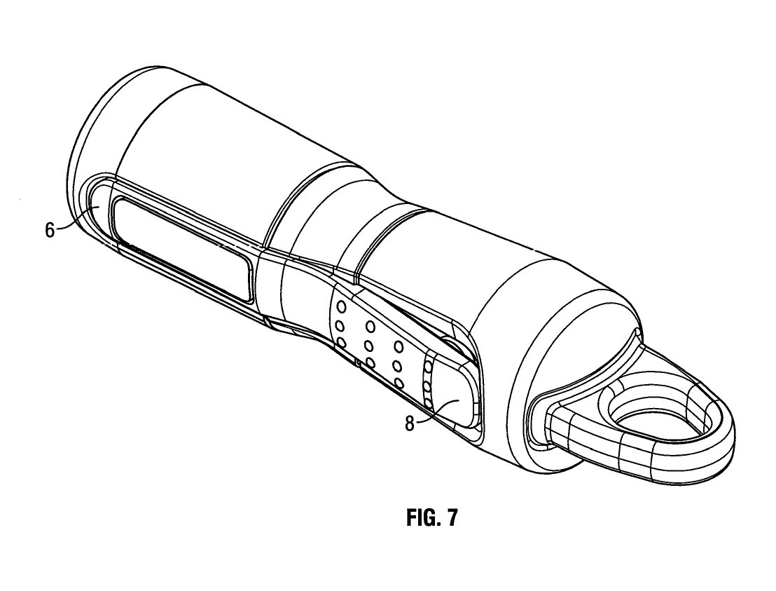

FIG. 7 shows a schematic perspective view of an assembled connector according to an exemplary embodiment of the present invention.

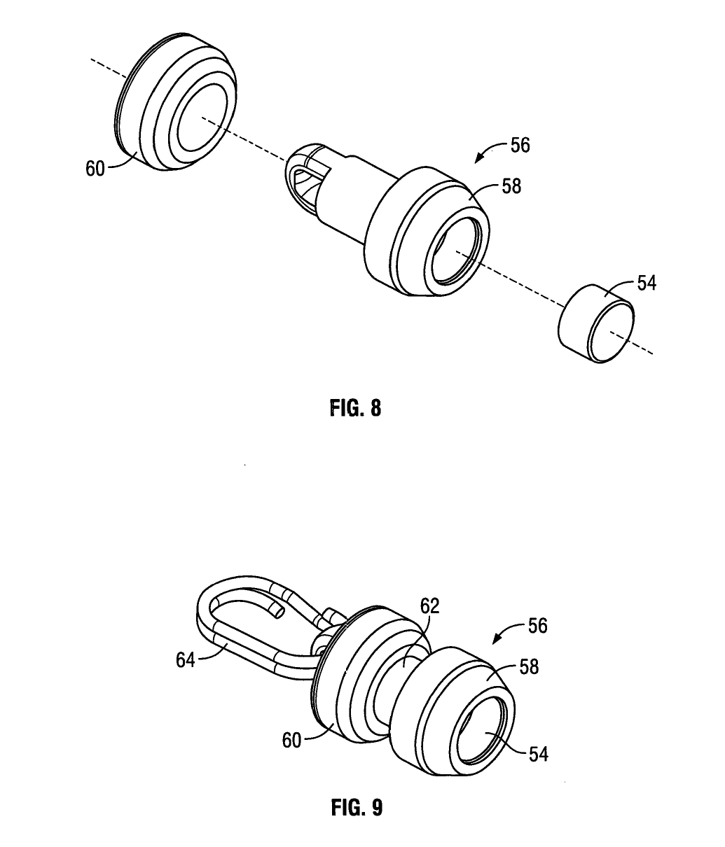

FIG. 8 shows a schematic perspective view of the components of assembly of the male engaging member for use in an exemplary embodiment of the present invention.

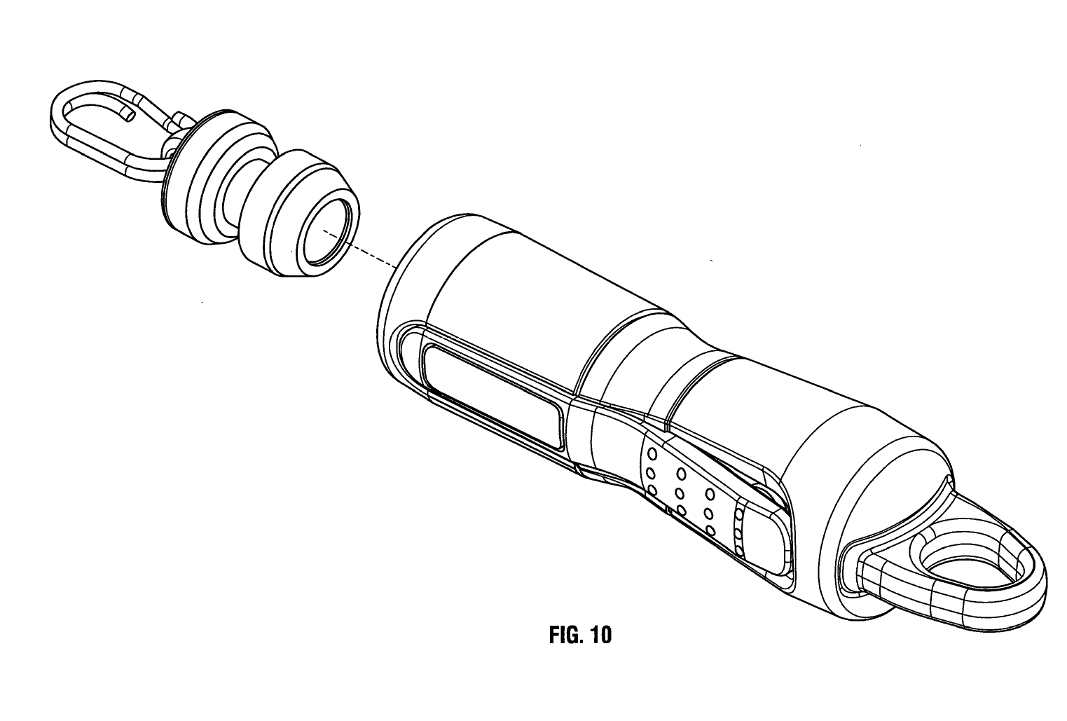

FIG. 9 shows a schematic assembled perspective view of a male engaging member according to an exemplary embodiment of the present invention.

FIG. 10 shows a schematic perspective view of the joining of a male engaging member with a female engaging member according to an exemplary embodiment of the present invention.

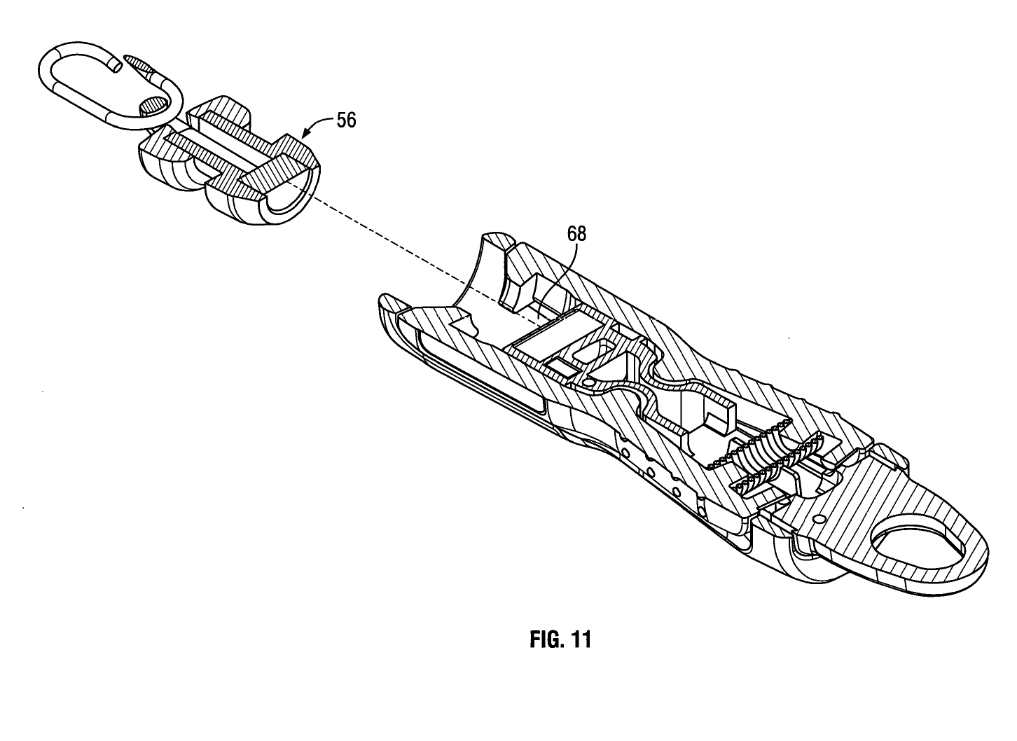

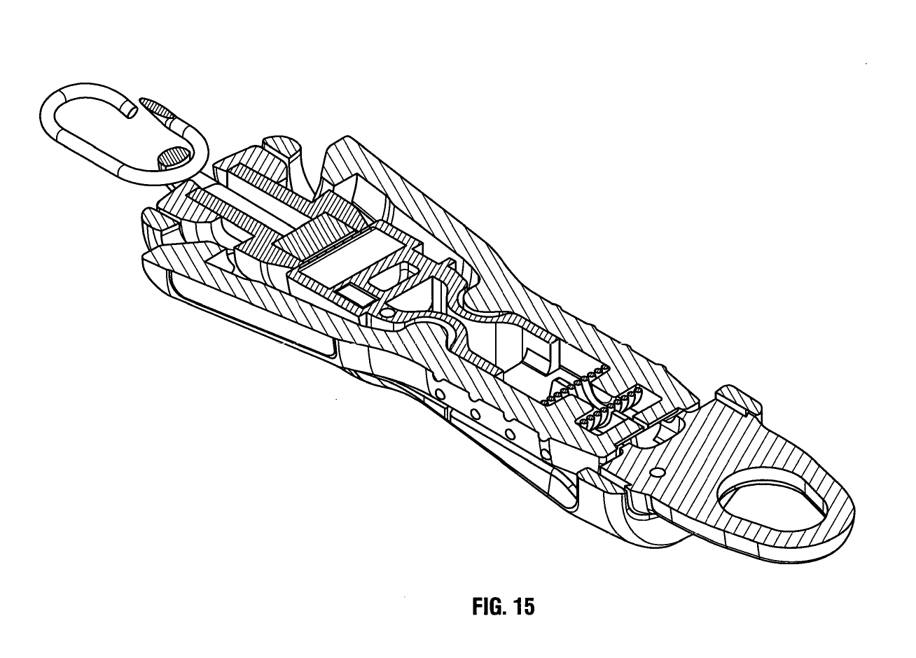

FIGS. 11 to 16 show insertion and subsequent removal of the male engaging member into a female body according to exemplary embodiments of the present invention in section view which clearly identify the component parts of the connector.

Referring to FIG. 1, there is shown two opposing clips 2 for retaining a male engaging member in the receiving chamber of a female body. The clips 2 are elongate and are rotatable about the vertical axis identified by reference numeral 4. The clips have a first end 6 and second end 8. The clips 2 comprise a first body engagement element 10 which is arranged to resist movement in the longitudinal axis of the female body. The first body engagement element in one embodiment beneficially comprises a spigot 10 which is arranged to seat into a corresponding recess 12 in the body portion of the connector. There is provided a first and second connector body engagement element 10 extending in opposing directions which seat in recesses 12 which allow rotational movement of the clip 2 about the spigot 10. It will be appreciated that in an alternative embodiment the clip 2 may comprise an opening or receiving portion for receipt of a spigot provided in the body portion.

The clip 2 comprises a head 14 which comprises a retaining element 16 which beneficially tapers radially inwardly on an outwardly projecting surface which is shaped in this manner such that on insertion of a male engaging element, the male engagement element has a correspondingly shaped contact surface which communicates with the tapered surface of the head 14 and causes radial outward deflection of the clips. This is due to the male engaging element effectively opening the clips, beneficially due to the attraction of the magnet, drawing the head 14 into the receiving chamber. The retaining element 16 further comprises a retaining surface 18 which effectively forms a shoulder which cooperates in the closed configuration with a shoulder provided on the male engaging element.

A biasing means identified by a spring 20 in FIG. 1 locates between first and second clips 2 and seats onto a spigot 22. This has the effect of pushing the clip 2 to the closed configuration.

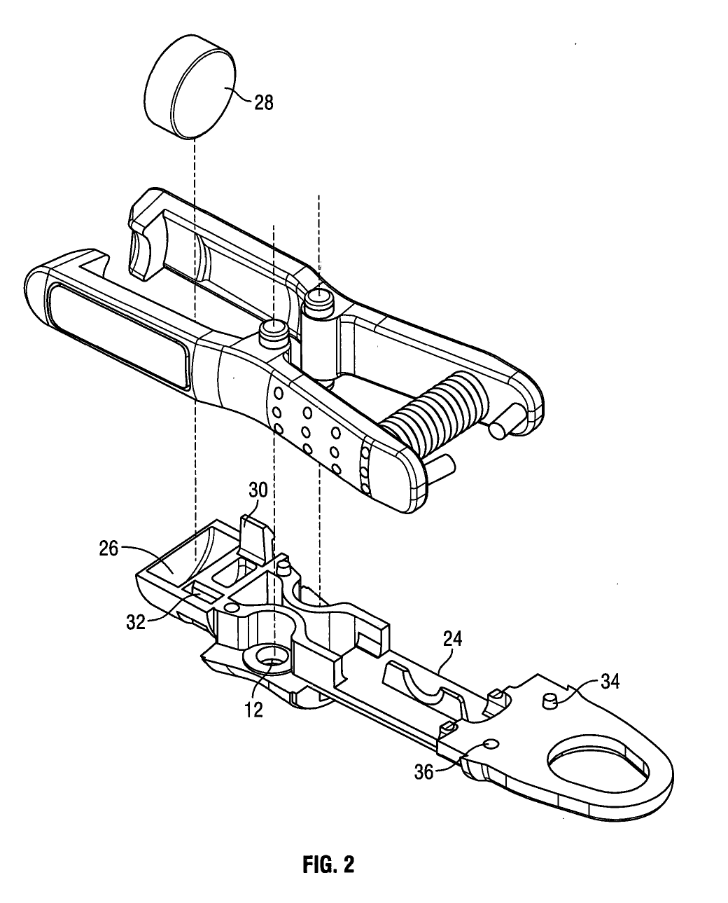

Referring to FIG. 2, once the spring 20 is positioned between the first and second clips 2 the spigots 10 are seated into corresponding recesses 12 provided in a first body portion of the female body. It will however be appreciated that at least one clip 2 can be seated into the recess 12 prior to positioning of the spring 20. A cavity or receiving area is provided in the first body portion 24 identified by reference numeral 26 into which a cylindrical magnet 28 is seated. A clip 30 is provided on the first body portion 24 arranged to locate into the corresponding opening into the second body portion. A further cavity or opening 32 is provided in the first body portion 24 for receipt of a corresponding clip provided by the second body portion in order to secure the first body portion to the second body portion. Furthermore, a spigot 34 and opening 36 are provided on the first body portion 24 arranged to communicate with the second body portion to ensure alignment and connection therebetween.

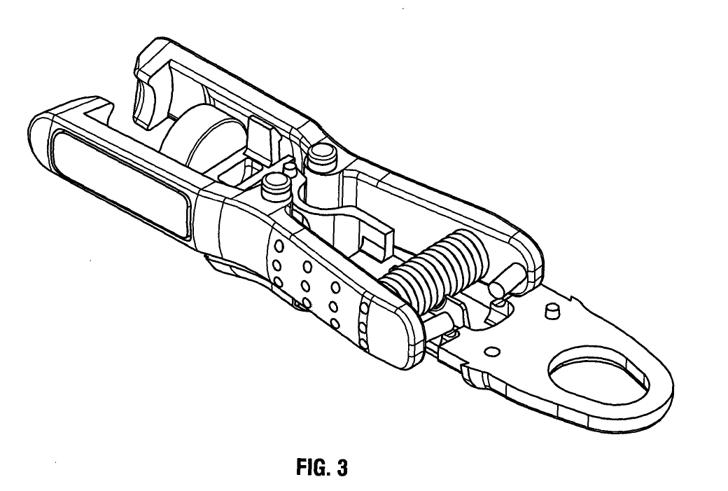

FIG. 3 shows the assembly of the components identified in FIG. 2.

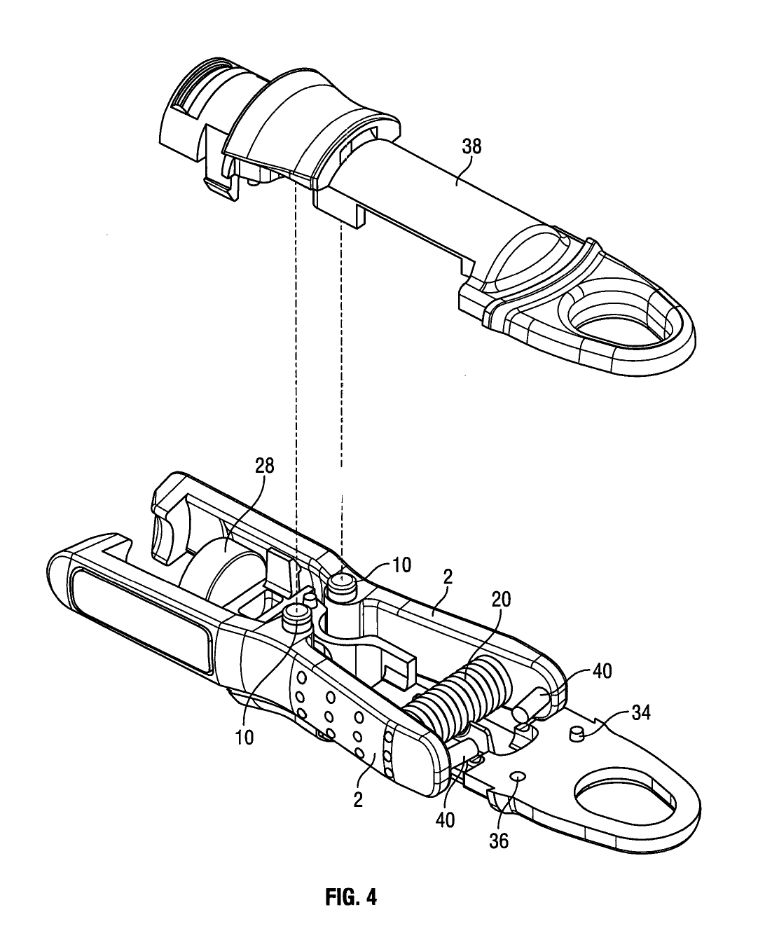

FIG. 4 shows the relative positioning of the second body portion 38 as it secures to the first body portion 24 via clip 30 and cavity 32, spigot 34 and opening 36 and where the second body portion 38 and its recesses provided therein seat onto spigots 10. It will also be appreciated with respect to FIG. 4 that projections 40 are provided generally opposing one another such that as the clips 2 are pushed towards one another against the spring 20, these projections 40 limit movement inwardly as they come into contact with one another thus preventing further inward compression.

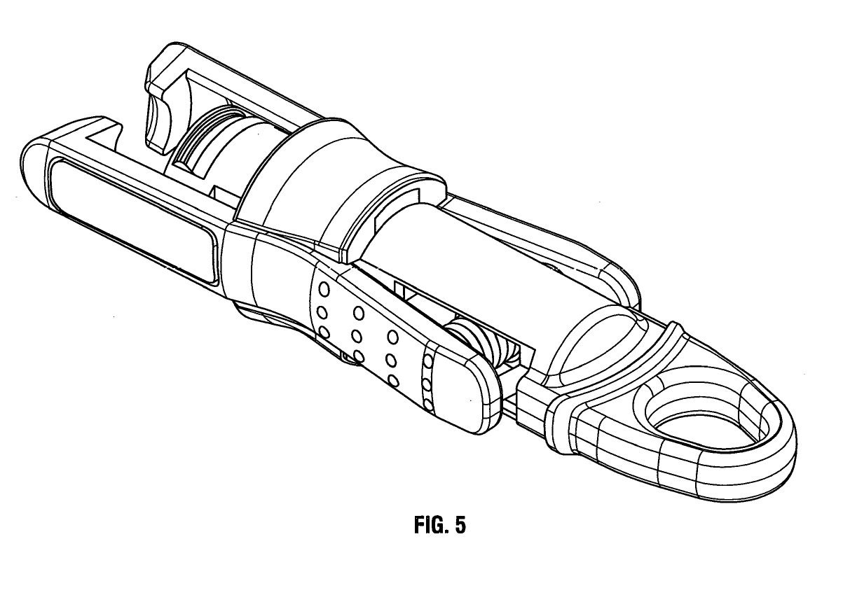

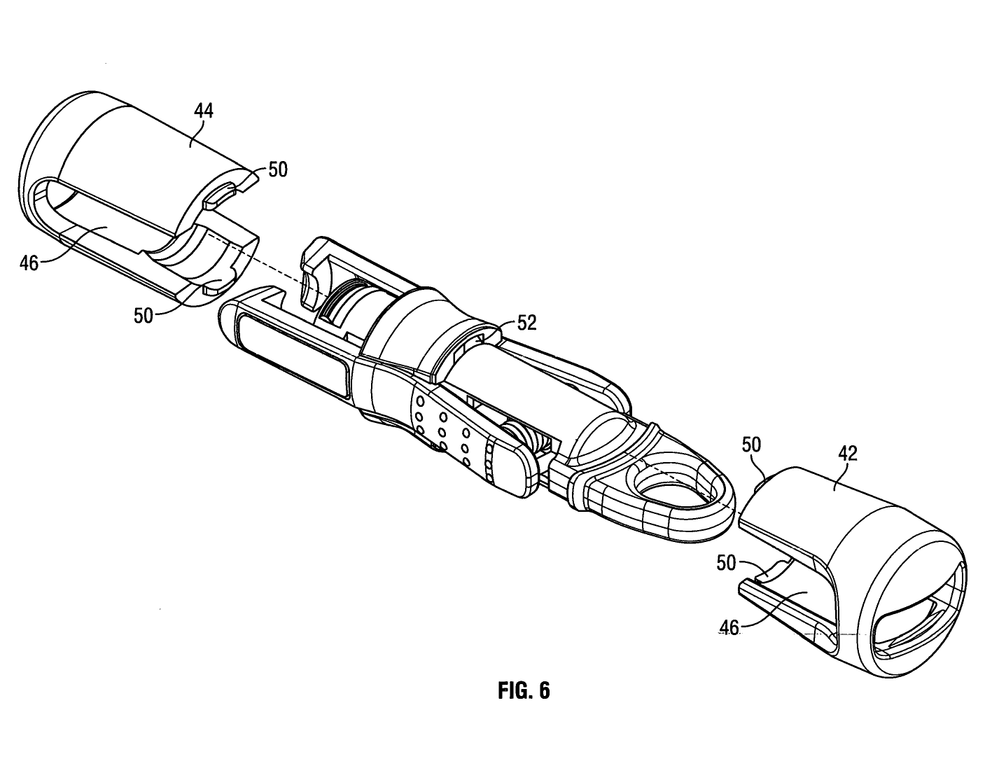

FIG. 5 shows the second body portion secured to the first body portion and clips 2 and FIG. 6 shows first and second collars 42,44 wherein the first collar 42 comprises grooves 46 therein to accommodate second end 8 of the clip 2. The second collar 44 also comprises a groove or channel to receive the first end of the clip 6. The first and second collars 42, 44 secure to the first and second body portions 24, 38. The first collar 42 comprises an opening through which a connection point projects which connects to, for example, the lead for a dog. Securing is achieved via clips 50 and corresponding openings provided in the first and second body portions 24,38 respectively, identified by reference numeral 52. In this configuration as identified in FIG. 7, the connector is fully assembled and the clips 2 are effectively retained whereby compression of the clip 2 at the second end 8 radially inwardly causes compression of the spring 20, rotation of the clip 2 about the spigot 10 and causes corresponding deflection of the first end set radially outwardly allowing the connector to be in the release configuration.

Referring now to FIGS. 8 and 9, the male engaging portion is shown. The male engaging portion includes an element capable of being attracted by a magnet which is beneficially in the form of cylindrical element 54. This cylindrical element is received in a head 56 and seats against a rim. The head 56 has a tapering outward clip contact surface 58 which tapers towards the tip of the male engaging element. A collar portion 60 is further provided which seats near the head 56 and between the collar 60 and head 56, is defined as axial groove 62 into which the retaining element 16 is arranged to seat in the closed configuration. The tapered surface 58 is tapered to generally correspond to the taper provided on the outwardly facing tapered surface of the retaining element 16. This is such that as the magnet 28 attracts the cylindrical element 54 the male engaging member is drawn into the opening provided in the connector and forces the first end 6 of the retaining clip 2 radially outwardly.

The arrangement of the male engaging element as shown in FIGS. 8 and 9 enables simple forming in plastic. An end loop 64 is provided which is simple to connect to the ring on a dog's collar for example. The male engaging element is beneficially made from glass-filled nylon for superior strength, however, the collar portion 60 which does not support any load in use is made of standard nylon which reduces cost.

FIG. 10 is a schematic perspective view of the male engaging element in the direction to be received by the connector. Referring to FIG. 10 in some detail, the male engaging element is shown in alignment with the female body. It will be appreciated that in use this is unlikely and the description will now be made with reference to an embodiment wherein the connector is used for a dog collar. The male engaging element is attached to a ring on a dog collar by a generally oval end loop 64 which is shaped as such to allow maximum alternative orienting of the male engaging element with respect to the collar to which it is secured. This male engaging element then hangs from a dogs collar thus weight is extremely important as a reduction in weight minimises any impedance to the dog. When connection is required, a user grasps the female body and brings the female body into the vicinity of the male engaging element. The male engaging element has compliance meaning that it has significant freedom of movement to allow the head 56 to locate into the female body. Force of attraction from a magnet provided in the female body causes the alignment of the male engaging element even if the female body is not accurately aligned with the longitudinal axis of the male engaging element. Furthermore, the tapered surface of the clip contact surface 58 beneficially aids an engagement of the male engaging element with the female body and in particular allows initial engagement with the collar 44 and additional attraction by the magnet then draws the male engaging element into alignment in the longitudinal axis. Accordingly, one-handed connection of the female body to the male engaging element is achieved.

Referring to FIGS. 11 to 16, a perspective cross-sectional view of the female body and male engagement element are shown during the steps of connection and subsequent release.

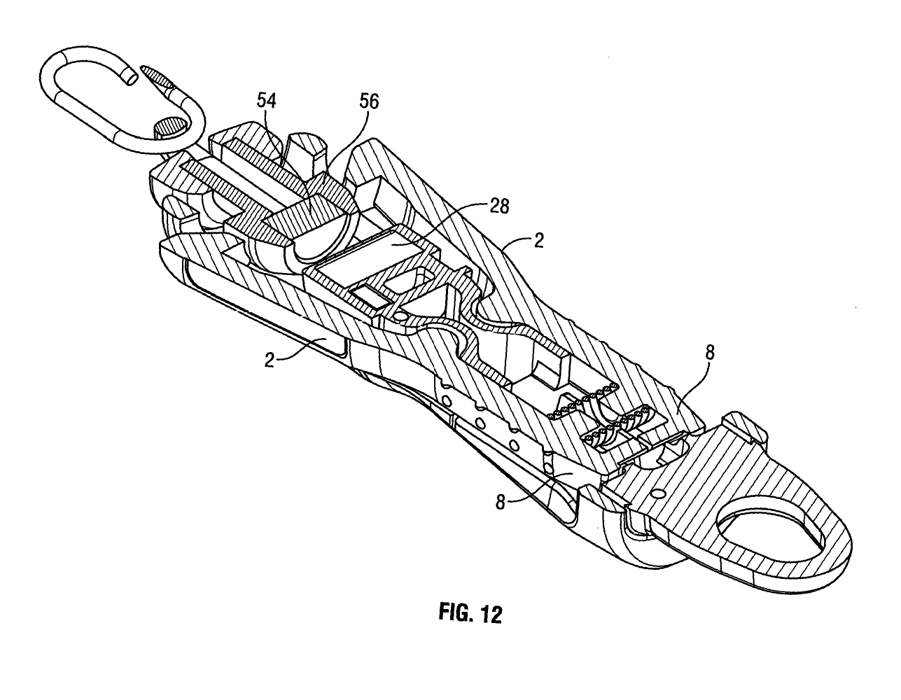

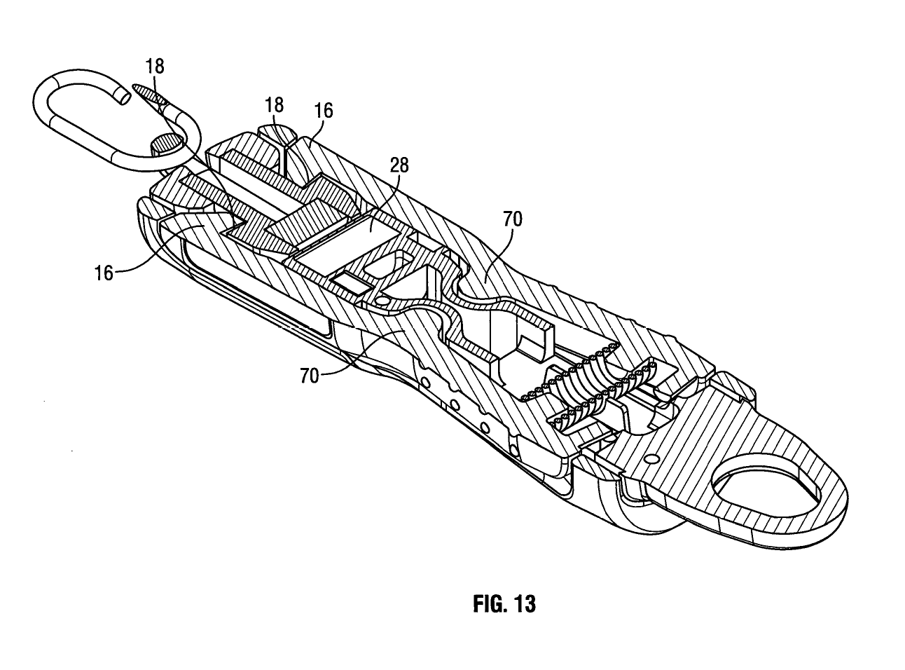

Referring to FIGS. 11 and 12, as the male engaging element comes into communication with the clips 2, the clips are forced radially outwardly thus allowing the head 56 of the male engaging element to be received in the receiving chamber 68. The magnet 28 causes attraction of the cylindrical element 54 and thus for the purposes of connection there is no requirement for compression of the second end 8 by a user. Once fully inserted as shown in FIG. 13, the clips 2 return to the at rest configuration which is the closed configuration and the retaining element 16 prevents movement of the male engaging element in the longitudinal axis relative to the connector. The magnet 28 also acts to prevent relative movement in the longitudinal axis but rotational movement between the male engaging element and the female body is allowed. It will be appreciated that with reference particularly to FIG. 13, the force provided on the male engaging element is pulled through the retaining element 16 and directly through the retaining surface 18. It will further be appreciated that this force is directly in line with the longitudinal axis through which the clips rotate identified by reference numeral 70. This is important as force applied to the male engaging element in the axial direction combined with a rotational force or twisting of the male engaging element will not force the clips apart and in particular force the retaining element 16 apart causing accidental release.

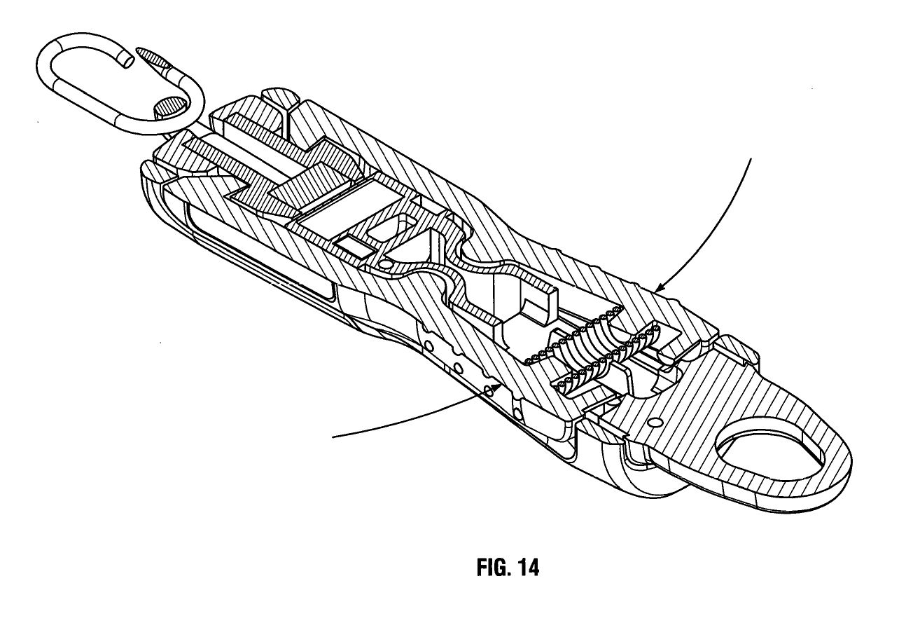

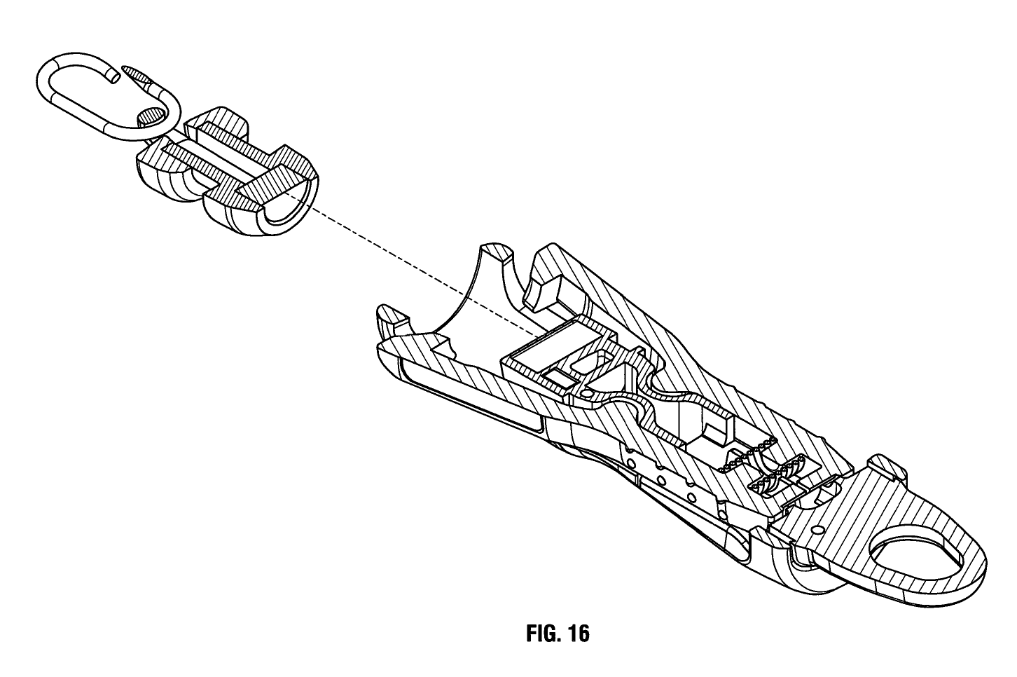

As identified in FIG. 14, when release is required force is applied by a user pinching the clips 2 in the direction identified by the arrows. This causes release of the retaining elements 16 from retaining the head of the male engaging element 56 from the axial groove 62 meaning that the male engaging element can be released as identified in FIG. 16.

The present invention has been described by way of example only and it will be appreciated by the skilled addressee that modifications and variations may be made without departing from the scope of protection afforded by the appended claims.

1. A connector comprising:
a female body having a longitudinal axis comprising a first body portion and a second body portion arranged to communicate to define a receiving chamber for receipt of a male engaging member; and
a retaining clip for retaining a male engaging member in the receiving chamber, the retaining clip being moveable between an open configuration for receipt of a male engaging member and a closed configuration for restraining movement of a male engaging member in the longitudinal axis;
wherein the first and second body portions are arranged to retain the retaining clip therebetween.

2. The connector according to claim 1, wherein the female body is arranged to receive an element capable of being attracted by a magnet.

3. The connector according to claim 2, wherein the female body includes a magnet and is arranged and configured to retain one or both of the element and magnet therein.

4. The connector according to claim 3, wherein the female body comprises a receiving zone for the magnet formed by the first and second body portions.

5. The connector according to claim 1, wherein the retaining clip is arranged to move from the closed configuration to the open configuration upon transfer of a male engaging member into the chamber.

6. The connector according to claim 1, wherein the retaining clip is at least partially moveable between a radially outwardly open configuration and a radially inwardly closed configuration.

7. The connector according to claim 1, wherein the first and second body portions are radially separable.

8. The connector according to claim 1, wherein the first and second body portions define an annular opening into the receiving chamber.

9. The connector according to claim 1, wherein the retaining clip is rotationally moveable relative to the first and second body portions.

10. The connector according to claim 9, wherein the retaining clip is pivotally retained between the first and second body portions.

11. The connector according to claim 10, wherein the retaining clip is rotationally secured about an axis substantially perpendicular to the longitudinal axis of the female body.

12. The connector according to claim 9, wherein the retaining clip comprises a longitudinal length extending between a first and second end and is pivotally retained at a location intermediate the first end and the second end.

13. The connector according to claim 9, wherein the retaining clip comprises a first body engagement element for resisting movement in the longitudinal axis of the first body portion and a second body engagement element for resisting movement in the longitudinal axis of the second body portion.

14. The connector according to claim 13, wherein the first body engagement element and the second body engagement element comprise a spigot for seating into a receiving portion in the first body portion.

15. The connector according to claim 1 further comprising a second retaining clip, the two retaining clips being provided radially opposite each other on opposing sides of the female body portion.

16. The connector according claim 1, wherein the retaining clip comprises a retaining element arranged to retain a male engaging member in the receiving chamber in the closed configuration.

17. The connector according to claim 16, wherein the retaining element comprises a retaining surface arranged to seat against a male engaging member and prevent withdrawal of a male engaging member from the receiving chamber.

18. The connector according to claim 17, the retaining surface substantially aligns in the same longitudinal axis with the axis about which the retaining clip rotates.

19. The connector according to claim 17, wherein the retaining clip is arranged such that force applied to the retaining surface is in a longitudinal axis and this longitudinal axis beneficially intersects the axis about which the retaining clip rotates.

20. The connector according to claim 1 further comprising a biasing means, to bias the retaining clip to the closed configuration

21. The connector according to claim 20 further comprising a second retaining clip, wherein the biasing means extends between the two retaining clips.

22. The connector according to claim 1 further comprising at least one collar portion arranged to at least partially encase the first and second body portions.

23. The connector according to claim 1, wherein the retaining clip comprises a contact portion for contacting a male engaging member wherein the contact portion tapers inwardly enabling the retaining clip to be deflected radially outwardly on introduction of a male engaging member through the opening to the receiving chamber.

24. The connector according to claim 1 further comprising a male engaging member.

25. The connector according to claim 24, wherein the male engaging member comprises a head and a body portion separated by an axial groove.

26. A method of assembling the connector according to claim 1 comprising:
providing the female body;
providing the retaining clip;
positioning the retaining clip between the first body portion and second body portion such that the first body portion and second body portion retain the retaining clip therebetween; and
arranging the retaining clip to be capable of retaining a male engaging member in the receiving chamber;
wherein the retaining clip is moveable between an open configuration for receipt of a male engaging member and a closed configuration for restraining movement of a male engaging member in the longitudinal axis.
